(19) United States
(12) Patent Application Publication
(10) Pub. No.: US 2006/0280449 A1
(43) Pub. Date: Dec. 14, 2006

(54) Video display device and video display system

(75) Inventors: Hiroki Ogawa, Yamatokoriyama-shi (JP); Shigeo Akamatsu, Kashihara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/443,400

(22) Filed: May 31, 2006

(30) Foreign Application Priority Data
Jun. 7, 2005 (JP) 2005-166765 (P)
Apr. 10, 2006 (JP) 2006-107532 (P)

(51) Int. Cl. H04N 7/00

(52) U.S. Cl. 386/95

(57) ABSTRACT

A central processing unit of a video display device displaying a thumbnail image formed based on a content executes a program including the steps of: deleting all thumbnail images corresponding to copy-never contents if a prescribed time period passed from the time when a thumbnail image transmitted from a video recording/reproducing device was stored; and deleting all thumbnail images corresponding to copy-never contents if a content to be viewed is selected using a contents selection image on which thumbnail images are displayed.

This nonprovisional application is based on Japanese Patent Applications Nos. 2005-166765 and 2006-107532 filed with the Japan Patent Office on Jun. 7, 2005 and Apr. 10, 2006, respectively, the entire contents of which are hereby incorporated by reference.

### BACKGROUND OF THE INVENTION

1. Field of the Invention

The present invention relates to a video display device and a video display system displaying an image formed based on a content as a thumbnail image. More specifically, the present invention relates to a technique for displaying an image formed based on a content of which number of copies is restricted, as a thumbnail image.

2. Description of the Background Art

A video recording and reproducing device having a function of recording a broadcast program such as a television broadcast allowing time-shifted viewing at a time desired by the user has been well known. Conventionally, devices that record on a magnetic tape such as VHS (Video Home System) have been dominant. Recently, however, video recording and reproducing devices that use random-accessible recording medium such as a DVD (Digital Versatile Disk) or a hard disk come to be dominant. Such recording medium allows higher speed of operation, larger capacity and higher image quality than the magnetic tape, and therefore, it becomes possible to store a large amount of contents in one video recording and reproducing device. A conventional VHS tape typically has recordable time of about 2 hours with standard image quality, while a hard disk of 250 GB (Giga Byte: giga=10⁹) allows recording of about 100 hours or longer, with standard image quality. In other words, contents of about 50 VHS tapes can be stored in one image recording and reproducing device. Further, it becomes possible these days to form a network at home using a plurality of video recording and reproducing devices and a video display device, to display contents recorded by a video recording and reproducing device on the network on the video display device through the network and to view the contents. It is possible for a user to operate, through the video display device, the plurality of video recording and reproducing devices on the network. With the large amount of contents, however, it takes long time for the user to find and select a desired content. To make it easier for the user to quickly find and select the desired content, thumbnail display technique has been proposed, in which thumbnail images as representative images serving as indexes are displayed, to help the user scan through and recognize the substance of viewable contents. Such thumbnails are prepared by forming beforehand images reduced in size from the original contents and stored separately from the original contents, so that quick display is possible.

Japanese Patent Laying-Open No. 2000-350124 discloses a dynamic image recording and reproducing device in which, during recording of dynamic image signals, a still image reduced in size and allowing identification of the content of the dynamic image signals is recorded together with the dynamic image signals on a recording medium, so that the still image reduced in size can be used as an index of the recording medium. The dynamic image recording and reproducing device described in Japanese Patent Laying-Open No. 2000-350124 includes an image recording unit recording the input dynamic image signals on a recording medium, an extracting unit extracting a still image at a prescribed sampling rate from the dynamic image signals, a calculating unit calculating an evaluation value of the still image using a pixel value of the still image extracted by the extracting unit, a detecting unit detecting a local maximum of the evaluation value calculated by the calculating unit, a generating unit generating a representative image by reducing the still image corresponding to the local maximum of the evaluated value detected by the detecting unit, a recording unit recording the representative image generated by the generating unit on the recording medium, a reading unit reading the representative image recorded by the recording unit from the recording medium, and a forming unit forming a list of representative images by adhering at least one representative image read by the reading unit.

According to the dynamic image recording device described in the published application, the still image is extracted at a prescribed sampling rate from the input dynamic image signals, evaluation value of the still image is calculated using the pixel value of the still image, and a still image corresponding to the local maximum of the evaluation value is reduced in size and recorded as a representative image. Therefore, it is possible when a television program is recorded, to record a representative image that allows recognition of the program content.

Digital data allows production of a large number of copies without degradation. Rapid and widespread use of digital contents these days have lead to increased importance of copyright protection. Copy control of contents has thus become essential. As copy control information of contents, pieces of information such as “unlimited number of copying permitted (Copy-Free)”, “copying once is permitted (Copy-Once)” and “copying not permitted (Copy-Never)” are distributed, embedded in the contents. Such copy control information can be set freely by a contents holder for every content. The content having such copy control information embedded can be reproduced only after correct authentication by the transmitting side and the receiving side, and eavesdropping or interception on the transmission path is difficult as the data are sent in encrypted manner. DTCP-IP (Digital Transmission Content Protection over Internet Protocol) is one of the copyright protection systems. This manages device authentication, key exchange and contents encryption for handling digital contents on a network. According to the copy control technique used here, a copy-once content is turned to a copy-never content once it is recorded on a video recording and reproducing device, and further copying to another video recording and reproducing device is impossible, as shown in FIG. 21. At this time, whether a thumbnail image formed based on the copy-never content is considered as a part of the content or not poses a problem. If the thumbnail image were considered as a part of the content, storage of the thumbnail image would be regarded as copying of the content. Therefore, it is necessary to display the thumbnail in consideration of restriction posed by copy control.

Japanese Patent Laying-Open No. 2002-152667 discloses a recording/reproducing device realizing the thumbnail function without violating the copy restriction, when recording a source where copying of only one generation is permitted. The recording/reproducing device described in Japanese Patent Laying-Open No. 2002-152667 includes: a reproducing unit reproducing video data stored on the recording medium, the video data including video signals and a copy control signal; and a storing unit reducing the size of a designated image of the video data and storing the reduced image on the recording medium. For the video image of which copying is permitted only once (one generation) by the copy control signal, storage of the reduced-size image is prohibited. For the video image of which only one-generation copying is permitted by the copy control signal, position information pointing the position where the designated image of the video image is stored, is stored in the storage medium.

According to the recording/reproducing device described in the laid-open application, when a “copy free” source is recorded, it is possible to form a reduced image beforehand and to display the same quickly at the time of display. When the “one-generation copy permitted” source is recorded, however, the reduced image is not formed (or stored), so as to prevent violation of “copy restriction.” Even when the “one-generation copy permitted” source is recorded, it is possible to realize the thumbnail display function, as the pointer indicating the position where the original image that serves as the thumbnail image is held in the video image is stored.

The technique of Japanese Patent Laying-Open 2000-350124 does not consider the copy restriction at all. The recording/reproducing device described in Japanese Patent Laying-Open No. 2002-152667 simply holds the pointer for a copy-once content, and displays the original image of the content by accessing to the video image file (original content) at the position pointed by the pointer. Here, if the original image has a large number of pixels, or if the number of contents themselves is large, the amount of data to be processed to display thumbnails increases accordingly. With large amount of data, the time necessary until the thumbnail image is displayed would be too long, or the burden on the recording/reproducing device would be too heavy. Therefore, it is preferred that the image displayed as a thumbnail image be formed based on the content, so that the amount of data can be reduced by reducing the size of the image.

### SUMMARY OF THE INVENTION

An object of the present invention is to provide a video display device and a video display system that can display an image formed based on a content, while properly addressing the problem of copy restriction.

According to an aspect, the present invention provides a video display device displaying an image formed based on a content. The video display device includes: a forming unit forming the image based on the content; a storage unit storing the image; a display unit on which the stored image is displayed; and a deleting unit deleting the image stored in the storage unit based on information defining condition of use of the content.

By the present invention, the image formed based on the content is stored, and the stored image is displayed on the display unit. The image is deleted based on a piece of information that defines the condition or conditions of use of the content. By way of example, the condition that a prescribed time period has passed from when the image was stored, the condition that the image is selected to view the content, or the condition that the power of video display device is turned off is satisfied, the image formed based on the content of which number of permitted copying is smaller than a predetermined number is deleted. Therefore, when the thumbnail image is considered as a part of the content, copying of the content in the form of storage of the thumbnail image can be prevented. Therefore, the problem of copy restriction raised by forming the thumbnail image can be avoided. As a result, a video display device that can display an image formed based on the content while properly addressing the problem of copy restriction can be provided.

Preferably, the information defining the condition of use of the content is the number of permitted copies of the content.

By way of example, when the condition that a prescribed time period has passed from when the image was stored, the condition that the image is selected to view the content, or the condition that the power of video display device is turned off is satisfied, the image formed based on the content of which number of permitted copying is smaller than a predetermined number is deleted. Therefore, when the thumbnail image is considered as a part of the content, copying of the content in the form of storage of the thumbnail image can be prevented. Therefore, the problem of copy restriction raised by forming the thumbnail image can be avoided. As a result, an image formed based on the content can be displayed while properly addressing the problem of copy restriction.

More preferably, the deleting unit deletes, when a predetermined condition is satisfied, an image formed based on a content of which number of permitted copies is smaller than a prescribed number.

By way of example, when the condition that a prescribed time period has passed from when the image was stored, the condition that the image is selected to view the content, or the condition that the power of video display device is turned off is satisfied, the image formed based on the content of which number of permitted copying is zero is deleted. Therefore, when the thumbnail image is considered as a part of the content, copying of the content in the form of storage of the thumbnail image can be prevented. Therefore, the problem of copy restriction raised by forming the thumbnail image can be avoided. As a result, an image formed based on the content can be displayed while properly addressing the problem of copy restriction.

More preferably, the predetermined condition is that a prescribed time period has passed from when the image was stored.

By the present invention, when the condition that a prescribed time period has passed from when the image was stored is satisfied, the image formed based on the content of which number of permitted copying is zero is deleted. Therefore, when the thumbnail image is considered as a part of the content, copying of the content in the form of storage of the thumbnail image can be prevented. Therefore, the problem of copy restriction raised by forming the thumbnail image can be avoided. As a result, an image formed based on the content can be displayed while properly addressing the problem of copy restriction.

More preferably, the predetermined condition is that the image is selected for viewing the content.

By the present invention, when the condition that the image is selected to view the content is satisfied, the image formed based on the content of which number of permitted copying is zero is deleted. Therefore, when the thumbnail image is considered as a part of the content, copying of the content in the form of storage of the thumbnail image can be prevented. Therefore, the problem of copy restriction raised by forming the thumbnail image can be avoided. As a result, an image formed based on the content can be displayed while properly addressing the problem of copy restriction.

More preferably, the predetermined condition is that power of the video display device is turned off.

By the present invention, when the condition that the power of video display device is turned off is satisfied, the image formed based on the content of which number of permitted copying is zero is deleted. Therefore, when the thumbnail image is considered as a part of the content, copying of the content in the form of storage of the thumbnail image can be prevented. Therefore, the problem of copy restriction raised by forming the thumbnail image can be suppressed. As a result, an image formed based on the content can be displayed while properly addressing the problem of copy restriction.

More preferably, the video display device further includes a processing unit performing a process not to delete an image formed based on a content of which number of permitted copies is larger than a predetermined number.

According to the present invention, a content of which number of permitted copying is one or more does not cause any problem even when it is copied once or more times. Therefore, the image formed based on such a content is not deleted. As a result, an image formed based on the content can be displayed while properly addressing the problem of copy restriction.

More preferably, the storage unit is formed by a volatile memory.

According to the present invention, the storage unit is formed by a volatile memory. Therefore, when the power of the video display device is turned off, the image is deleted without performing any particular processing. Therefore, when the thumbnail image is considered as a part of the content, copying of the content in the form of storage of the thumbnail image can be prevented. Therefore, the problem of copy restriction raised by forming the thumbnail image can be avoided. As a result, an image formed based on the content can be displayed while properly addressing the problem of copy restriction.

More preferably, the video display device further includes a volatile display memory storing data to be transmitted to the display unit. The storage unit is formed by the display memory.

According to the present invention, the storage unit is formed by a volatile memory for display, storing the data to be transmitted to the display unit. Therefore, when the power of the video display device is turned off, the image is deleted without performing any particular processing. Therefore, when the thumbnail image is considered as a part of the content, copying of the content in the form of storage of the thumbnail image can be prevented. Therefore, the problem of copy restriction raised by forming the thumbnail image can be avoided. . As a result, an image formed based on the content can be displayed while properly addressing the problem of copy restriction.

More preferably, the video display device further includes an obtaining unit obtaining the content and the information defining the condition of use of the content from a device different from the video display device.

According to the present invention, in the video display device that forms an image while obtaining a content and a piece of information defining the condition of use of the content from an external device, the image formed based on the content can be displayed while properly addressing the problem of copy restriction.

According to another aspect, the present invention provides a video display system including: the video display device; and a providing device connected through a network to the video display device and providing the content and the information defining the condition of use of the content to the video display device.

By the present invention, in the video display system including the video display device and a provider device connected to the video display device through a network and providing the content and the piece of information defining the condition of use of the content to the display device, the image formed based on the content can be displayed while properly addressing the problem of copy restriction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a control block diagram (part 1) representing a video display device in a video display system in accordance with a first embodiment of the present invention.

FIG. 2 is a control block diagram (part 2) representing a video display device in the video display system in accordance with the first embodiment of the present invention.

FIG. 3 is a control block diagram representing the video display system in accordance with the first embodiment of the present invention.

FIG. 4 is a flowchart representing a control structure of a program executed by a central processing unit of a video recording/reproducing device in the video display system in accordance with the first embodiment of the present invention.

FIG. 5 is a flowchart (part 1) representing a control structure of a program executed by a central processing unit of the video display device in the video display system in accordance with the first embodiment of the present invention.

FIG. 6 is a flowchart (part 2) representing a control structure of a program executed by the central processing unit of the video display device in the video display system in accordance with the first embodiment of the present invention.

FIG. 7 shows a contents selection image.

FIG. 8 shows a thumbnail when reproduction of a content is interrupted.

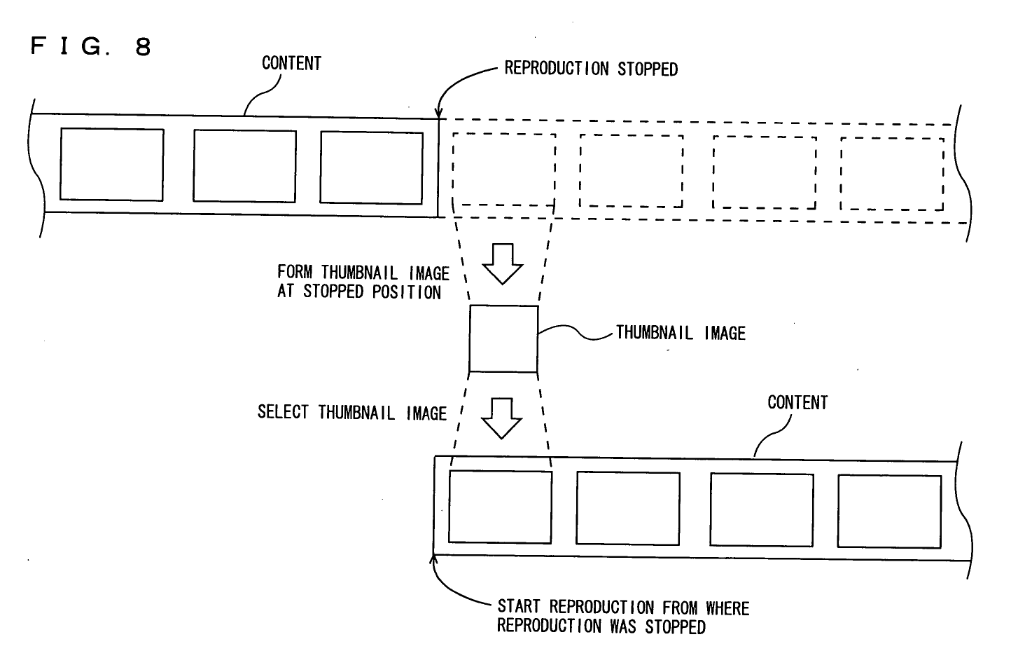

FIG. 9 is a control block diagram representing a video display device in a video display system in accordance with a second embodiment of the present invention.

FIG. 10 is a flowchart representing a control structure of a program executed by a central processing unit of a video recording/reproducing device in the video display system in accordance with the second embodiment of the present invention.

FIG. 11 is a flowchart (part 1) representing a control structure of a program executed by a central processing unit of the video display device in the video display system in accordance with the second embodiment of the present invention.

FIG. 12 is a flowchart (part 2) representing a control structure of a program executed by the central processing unit of the video display device in the video display system in accordance with the second embodiment of the present invention.

FIG. 13 is a control block diagram representing a video display device of a video display system in accordance with a third embodiment of the present invention.

FIG. 14 is a flowchart representing a control structure of a program executed by a central processing unit of the video display device in the video display system in accordance with the third embodiment of the present invention.

FIG. 15 is a flowchart representing a control structure of a program executed by a central processing unit of a video recording/reproducing device in the video display system in accordance with a fourth embodiment of the present invention.

FIG. 16 is a flowchart (part 1) representing a control structure of a program executed by a central processing unit of the video display device in the video display system in accordance with the fourth embodiment of the present invention.

FIG. 17 is a flowchart (part 2) representing a control structure of a program executed by the central processing unit of the video display device in the video display system in accordance with the fourth embodiment of the present invention.

FIG. 18 is a flowchart representing a control structure of a program executed by a central processing unit of a video recording/reproducing device in the video display system in accordance with a fifth embodiment of the present invention.

FIG. 19 is a flowchart (part 1) representing a control structure of a program executed by a central processing unit of the video display device in the video display system in accordance with the fifth embodiment of the present invention.

FIG. 20 is a flowchart (part 2) representing a control structure of a program executed by the central processing unit of the video display device in the video display system in accordance with the fifth embodiment of the present invention.

FIG. 21 illustrates a conventional concept of contents copying.

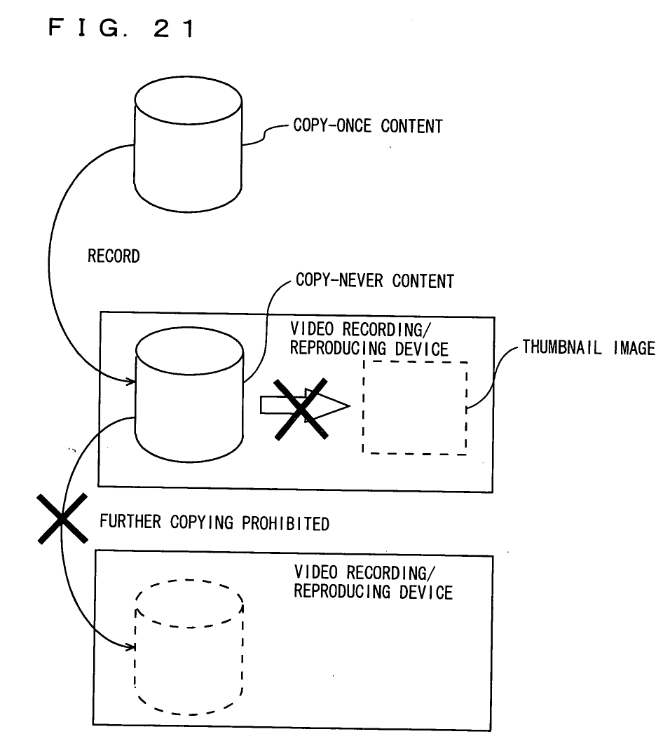

### DESCRIPTION OF THE PREFERRED EMBODIMENTS

In the following, embodiments of the present invention will be described with reference to the figures. In the following description, the same components are denoted by the same reference characters. They have the same names and functions, and therefore, detailed description thereof will not be repeated.

### First Embodiment

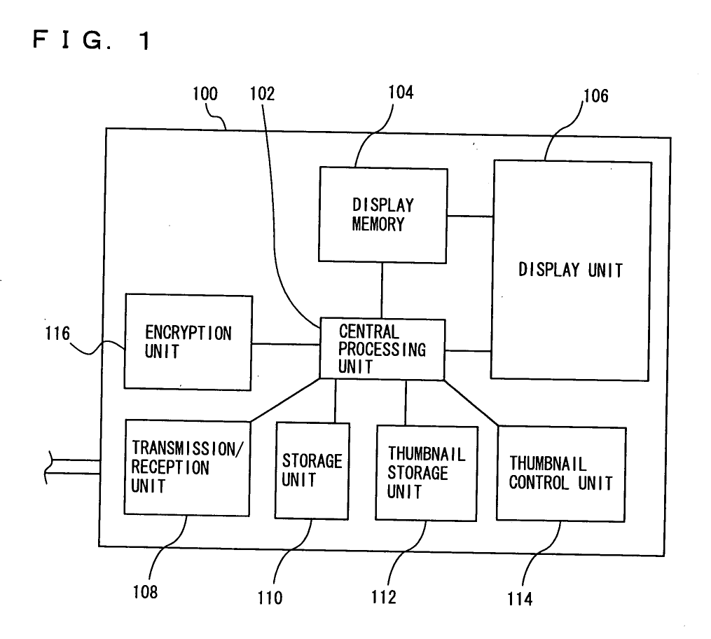

Referring to FIG. 1, the video display system in accordance with the present embodiment will be described. A video display device 100 included in the video display system includes a central processing unit 102, a display memory 104, a display unit 106, a transmission/reception unit 108, a storage unit 110, a thumbnail storage unit 112, a thumbnail control unit 114 and an encryption unit 116.

Central processing unit 102 is for overall control of video display device 100. Display memory 104 stores and successively sends to display unit 106 data for displaying contents and the like on display unit 106.

Display unit 106 displays data sent from display memory 104. Display unit 106 is formed, for example, by a liquid crystal display screen and its control unit. Transmission/reception unit 108 exchanges various pieces of information, contents and the like between video display device 100 and an external device.

Storage unit 110 is for storing contents and the like. Thumbnail storage unit 112 is for storing thumbnails. Thumbnail control unit 114 stores a thumbnail in thumbnail storage unit 112 or deletes a thumbnail from thumbnail storage unit 112, under administration of central processing unit 102. Encryption unit 116 decrypts a content, content identification information, a thumbnail and the like transmitted in encrypted form.

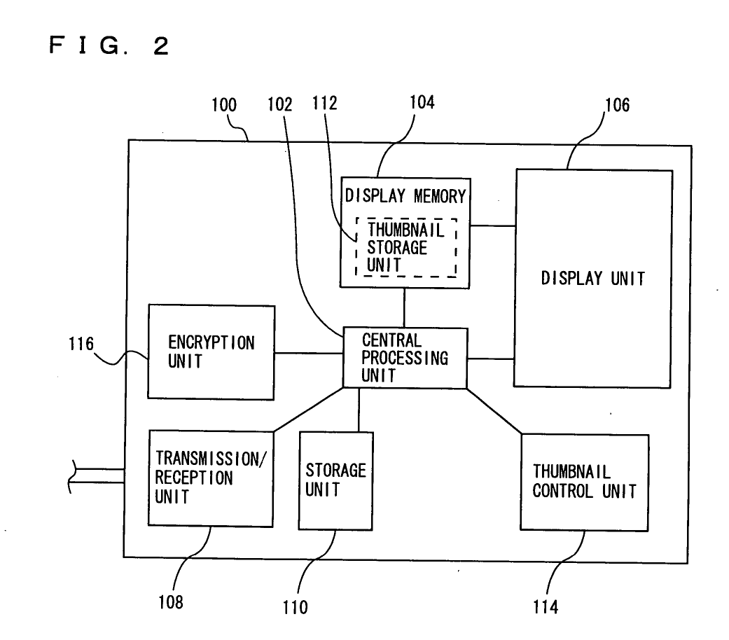

In video display device 100 shown in FIG. 1, thumbnail storage unit 112 is formed by a memory separate from storage unit 110 storing contents and the like or display memory 104. Storage unit 110 and thumbnail storage unit 112 may share the same memory area. Alternatively, a part of display memory 104 may be used to form thumbnail storage unit 112, as shown in FIG. 2.

Display memory 104, storage unit 110 and thumbnail storage unit 112 are formed of volatile memories. Therefore, when the power of video display device 100 is turned off, what have been stored in display memory 104, storage unit 110 and thumbnail storage unit 112 are deleted.

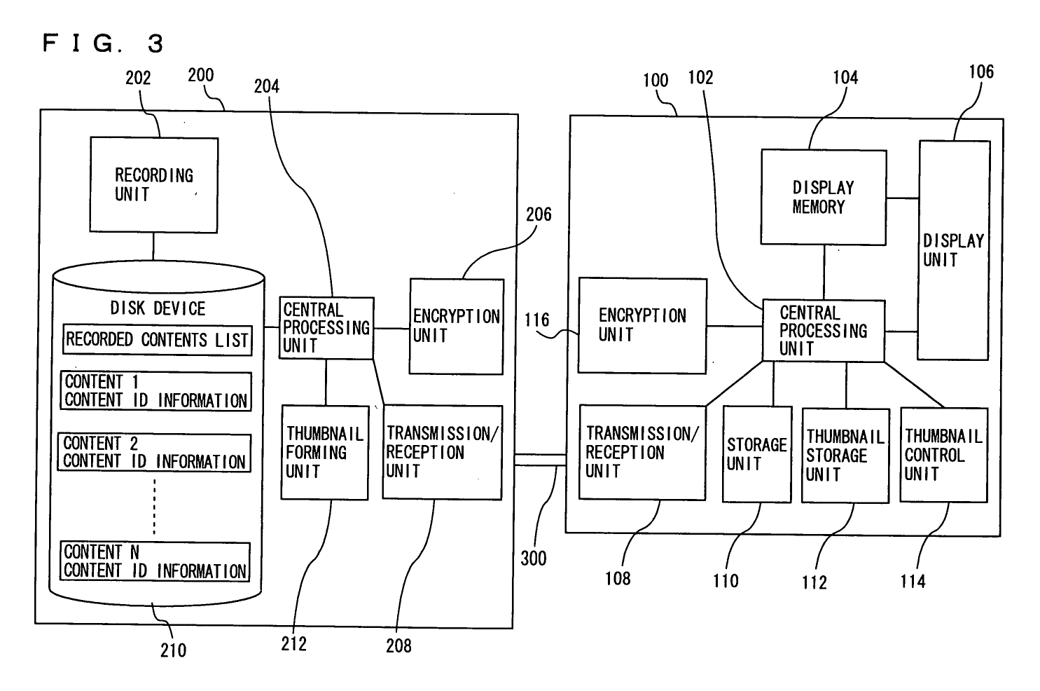

Referring to FIG. 3, the video display system in accordance with the present embodiment will further be described. In the video display system, a video recording/reproducing device 200 (transmitting side) such as a hard disk recorder is connected to video display device 100 (receiving side) such as a liquid crystal television, through an IP (Internet Protocol) network or the like (such as home network) 300.

The video display system in accordance with the present embodiment handles contents under copyright protection and, therefore, device authentication through DTCP-IP or the like is necessary, when devices are connected to each other. Therefore, device authentication is done between video display device 100 and video recording/reproducing device 200. The copyright-protected content that is passed between video display device 100 and video recording/reproducing device 200 is encrypted for transmission/reception.

Video recording/reproducing device 200 forms a thumbnail and transmits to video display device 100. Video display device 100 receives and displays the content and the thumbnail. From video recording/reproducing device 200 to video display device 100, video data in accordance with MPEG2-TS (Moving Picture Experts Group2-Transport Stream) is transmitted. The format of video data to be transmitted is not limited thereto.

Video recording/reproducing device 200 includes a recording unit 202, a central processing unit 204, an encryption unit 206, a transmission/reception unit 208, a disk device 210 and a thumbnail forming unit 212.

Recording unit 202 stores video data such as broadcasting waves in disk device 210. When a copy-once content is received and recorded, the content is recorded on disk device 210 in such a state that does not allow further copying to another device. In other words, the content that has been a copy-once content is recorded as a copy-never content, in disk device 210.

Central processing unit 204 is for overall control of video recording/reproducing device 200. Encryption unit 206 encrypts contents, content identification information, thumbnails and the like. Transmission/reception unit 208 passes various pieces of information, contents and the like between video recording/reproducing device 200 and external devices. Disk device 210 records a plurality of video data (contents).

Thumbnail forming unit 212 forms a thumbnail image of a content recorded on disk device 210. The formed thumbnail image may contain part of or all of a reduced-size representative image indicating characteristics of the content, a title of the content, date and time of recording the content, copy control information of the content, reproduction time of the content and the like. The reduced-size representative image of the content may be formed by reducing the size of a picture at a starting portion of MPEG2-TS data, or by any other method.

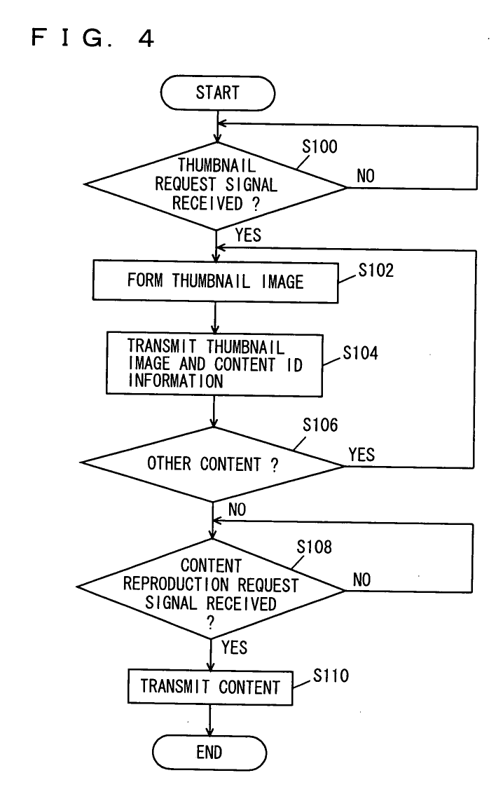

Referring to FIG. 4, the control structure of the program executed by central processing unit 204 of video recording/reproducing device 200 in the video display system in accordance with the present embodiment will be described.

At step (hereinafter simply denoted by S) 100, central processing unit 204 determines whether a thumbnail request signal from video display device 100 has been received or not. If the thumbnail request signal from video display device 100 has been received (YES at S100), the flow proceeds to S102. Otherwise (NO at S100), the flow returns to S100.

At step S102, central processing unit 204 forms a thumbnail image of the content recorded on disk device 210. The thumbnail image is formed at thumbnail forming unit 212. At S104, central processing unit 204 transmits the thumbnail image thus formed and content identification information, to video display device 100. The thumbnail image and the content identification information are encrypted by encryption unit 206 and transmitted through transmission/reception unit 208 to video display device 100.

At S106, central processing unit 204 determines whether there is any other content or not. If there is any other content (YES at S106), the flow returns to S102. Otherwise (NO at S106), the flow proceeds to S108. When there are a plurality of contents, the thumbnail images may be transmitted one by one or transmitted collectively at one time.

At S108, central processing unit 204 determines whether the content reproduction request signal from video display device 100 has been received or not. When the content reproduction request signal from video display device 100 has been received (YES at S108), the flow proceeds to S110. Otherwise (NO at S108), the flow returns to S108.

At S110, central processing unit 204 transmits the content to video display device 100. The content is encrypted at encrypting unit 206, and transmitted through transmission/reception unit 208 to video display device 100.

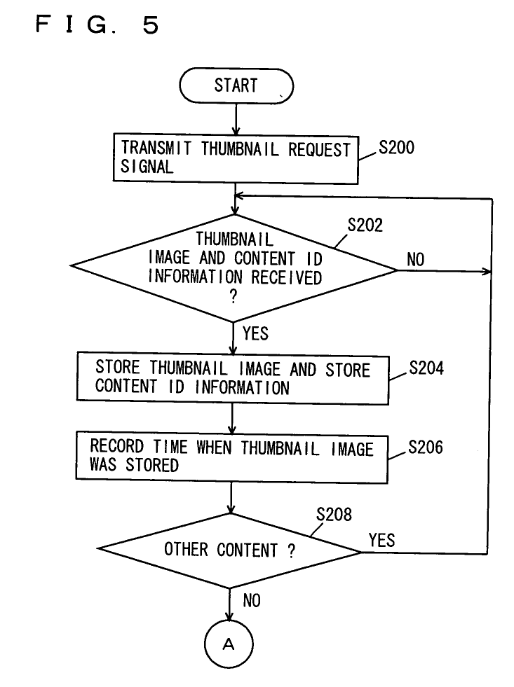

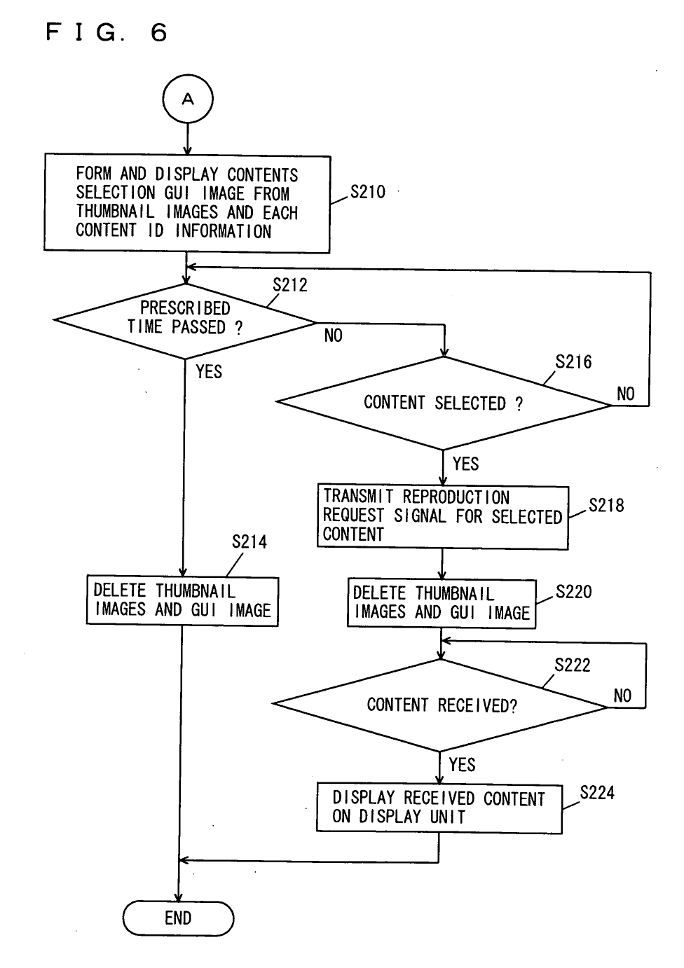

Referring to FIGS. 5 and 6, the control structure of the program executed by central processing unit 102 of video display device 100 in the video display system in accordance with the present embodiment will be described.

At S200, central processing unit 102 transmits a thumbnail request signal to video recording/reproducing device 200 based on, for example, a user operation. The thumbnail request signal is transmitted through transmission/reception unit 108 to video recording/reproducing device 200.

At S202, central processing unit 102 determines whether the thumbnail image and the content identification information have been received from video recording/reproducing device 200. If the thumbnail image and the content identification information have been received (YES at S202), the flow proceeds to S204. Otherwise (NO at S202), the flow returns to S202.

At S204, central processing unit 102 stores the thumbnail image and stores the content identification information. The thumbnail image is decrypted at encryption unit 116 and thereafter stored in thumbnail storage unit 112. The content identification information is decrypted at encryption unit 116 and thereafter stored in storage unit 110.

At S206, central processing unit 102 records the time point at which the thumbnail image was stored. The time point when the thumbnail image was stored is recorded at thumbnail control unit 114.

At S208, central processing unit 102 determines whether there is any other content. If there is any other content (YES at S208), the flow proceeds to S202. Otherwise (NO at S208), the flow proceeds to S210.

At S210, central processing unit 102 forms a GUI (Graphical User Interface) image for contents selection, utilizing the thumbnail images stored in thumbnail storage unit 112 and the content identification information stored in storage unit 110, and displays the GUI image on display unit 106 as a contents selection image.

At S212, central processing unit 102 determines whether a prescribed time period has passed from the time point when the thumbnail image was stored. When the prescribed time period has passed from the time point when the thumbnail image was stored (YES at S212), the flow proceeds to S214. Otherwise (NO at S212), the flow proceeds to S216. The prescribed time may be appropriately determined by the device or the system. It may be possible to have the prescribed time period changed by the user.

At S214, central processing unit 102 deletes all the thumbnail images that correspond to copy-never contents (the contents for which number of permitted copies is smaller than one) and the GUI image for contents selection. Deletion of the thumbnail images and the GUI image is done by thumbnail control unit 114. At this time, thumbnail images corresponding to contents of which number of permitted copies is one or more are not deleted.

Other than the copy-never contents, thumbnail images corresponding to contents of which number of permitted copies is smaller than a desired number may be deleted and thumbnail images corresponding to contents of which number of permitted copies is larger than a desired number may not be deleted. Alternatively, all the thumbnail images may be deleted.

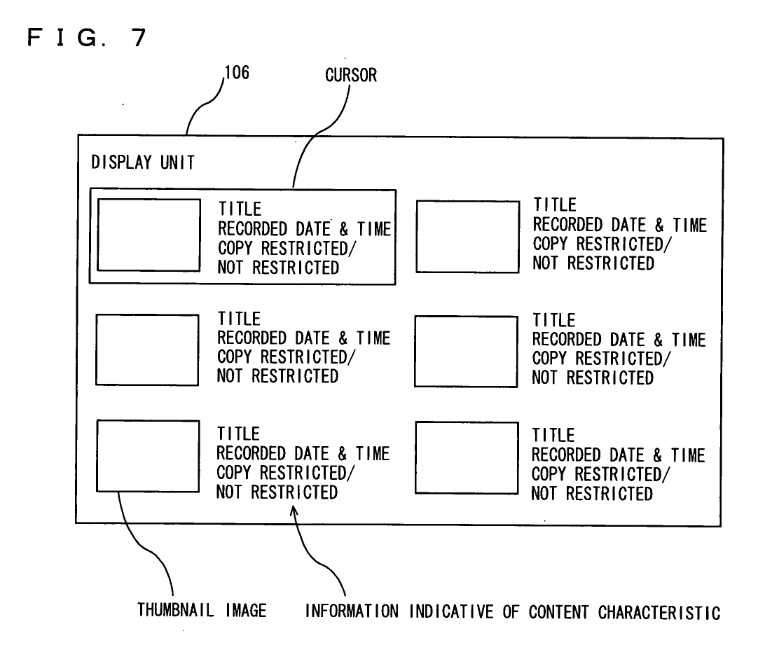

At S216, central processing unit 102 determines whether the user selected a content to be viewed or not. The user selects a content using the contents selection image displayed on display unit 106, as shown in FIG. 7. The content may be selected by any other method.

In the present embodiment, the contents selection image includes display of six thumbnail images and contents information. The contents selection image is not limited thereto. The user moves a cursor and selects a desired content while viewing information related to the characteristics of the contents, including the thumbnail images, titles, date and time of recording and presence/absence of any copy restriction, displayed on display unit 106.

Returning to FIG. 6, when a content is selected (YES at S216), the flow proceeds to S218. Otherwise (NO at S216), the flow proceeds to S212. At S218, central processing unit 102 transmits the reproduction request signal of the selected content to video recording/reproducing device 200. The content reproduction request signal is transmitted through transmission/reception unit 108 to video recording/reproducing device 200.

At S220, among the thumbnail images stored in storage unit 112, central processing unit 102 deletes all the thumbnail images corresponding to copy-never contents and the GUI image for contents selection. Deletion of the thumbnail images and the GUI image is done by thumbnail control unit 114. At this time, the thumbnail images corresponding to contents of which number of permitted copies is one or more are not deleted.

Other than the copy-never contents, thumbnail images corresponding to contents of which number of permitted copies is smaller than a desired number may be deleted and thumbnail images corresponding to contents of which number of permitted copies is larger than a desired number may not be deleted. Alternatively, all the thumbnail images may be deleted.

At S222, central processing unit 102 determines whether the content has been received from video recording/reproducing device 200. When the content has been received (YES at S222), the flow proceeds to S224. Otherwise (NO at S222), the flow returns to S222.

At S224, central processing unit 102 displays the received content on display unit 106. The content is decrypted at encryption unit 116 and thereafter displayed on display unit 106.

The operation of the video display system in accordance with the present embodiment based on the structure and flowchart as above will be described in the following.

By a user operation or the like, a thumbnail request signal is transmitted from video display device 100 to video recording/reproducing device 200 (S200). When the thumbnail request signal is received on the side of video recording/reproducing device 200 (YES at S100), a thumbnail image of the content is formed (S102), and the thumbnail image thus formed is transmitted, together with the content identification information, to video display device 100 (S104).

If there is any other content (YES at S106), formation of the thumbnail image (S102) and transmission of the thumbnail image and the content identification information (S104) are repeated.

When the thumbnail image and the content identification information are received on the side of video display device 100 (YES at S202), the thumbnail image is stored in thumbnail storage unit 112 and the content identification information is stored in storage unit 110 (S204). At this time, the time point when the thumbnail image was stored is recorded at thumbnail control unit 114 (S206).

If there is any other content (YES at S208), the process steps following S202 are repeated. The process steps following S202 are repeated, for example, until all the thumbnail images are received or until all the thumbnail images that can be displayed on one image plane are received.

Utilizing the thumbnail images and the pieces of content identification information received in this manner, the GUI image for contents selection is formed, and the GUI image is displayed on display unit 106 (S210).

In this state, if there is no user operation and the prescribed time period, for example, ten minutes, passes from the time point when the thumbnail image was stored (YES at S212), all the thumbnail images corresponding to the copy-never contents and the GUI image for contents selection are deleted (S214).

When a content is selected through the contents selection image displayed on display unit 106 (YES at S216), a content reproduction request signal is transmitted from video display device 100 to video recording/reproducing device 200 (S218).

At this time, correspondence between the thumbnail image and the original content can be established from the content identification information, and therefore, when the thumbnail image is selected on the contents selection image, a reproduction request signal for the original content is transmitted.

In this state, it follows that the thumbnail images and the GUI image for contents section are no longer necessary. Therefore, among the thumbnail images stored in thumbnail storage unit 112, all the thumbnail images corresponding to the copy-never contents and the GUI image for contents selection are deleted (S220).

When the content reproduction request signal from video display device 100 is received on the side of video recording/reproducing device 200 (YES at S108), the requested content is transmitted to video display device 100 (S110).

When the content is received on the side of video display device 100 (YES at S222), the content is displayed on display unit 106 (S224). Thus, the user views the content.

Thereafter, when the contents selection image becomes necessary at the time of stopping reproduction or at the end of reproduction, the process steps from S100 and from S200 are repeated. At this time, when reproduction is stopped in the middle of the content, for example, the last scene before stopping may be displayed as the thumbnail image on display unit 106, when the contents selection image is displayed next time. In that case, information as to the position where the content reproduction is stopped may be recorded, and the thumbnail image of that position may be formed by thumbnail forming unit 212 using the recorded position information.

As described above, according to the video display system in accordance with the present embodiment, the thumbnail image formed based on the content is deleted when a prescribed time period has passed from the time when it was stored, or when the thumbnail image is selected for reproducing (viewing) the content. Therefore, copying of the content in the form of storing a thumbnail image can be prevented. Therefore, even for a copy-never content, a thumbnail image formed based on the content can be displayed, without causing any problem of copy restriction.

As to the copy-free content of which number of copying is not at all limited, a thumbnail may be formed and displayed in the conventional manner, or it may be deleted when a predetermined condition is satisfied, as in the present embodiment.

The thumbnail image stored in thumbnail storage unit 112 may not immediately be deleted when a prescribed time period has passed from the time when it was stored, or when reproduction of the content starts and the operation exits the contents selection image.

### Second Embodiment

In the following, a second embodiment of the present invention will be described. The present embodiment differs from the first embodiment in that the thumbnail image is formed in video display device 100. Except for this point, the structure is the same as the first embodiment described above. The functions are also the same. Therefore, detailed description thereof will not be repeated here.

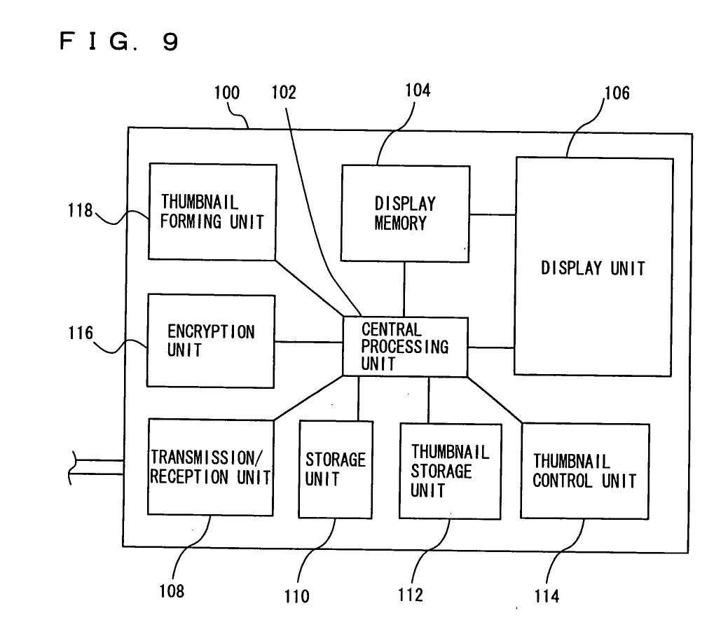

Referring to FIG. 9, video display device 100 in accordance with the present embodiment will be described. As shown in FIG. 9, video display device 100 includes a thumbnail forming unit 118. Thumbnail forming unit 118 does not obtain any thumbnail image from the outside. Thumbnail forming unit 118 forms, based on a content obtained through transmission/reception unit 108, a thumbnail image corresponding to the content.

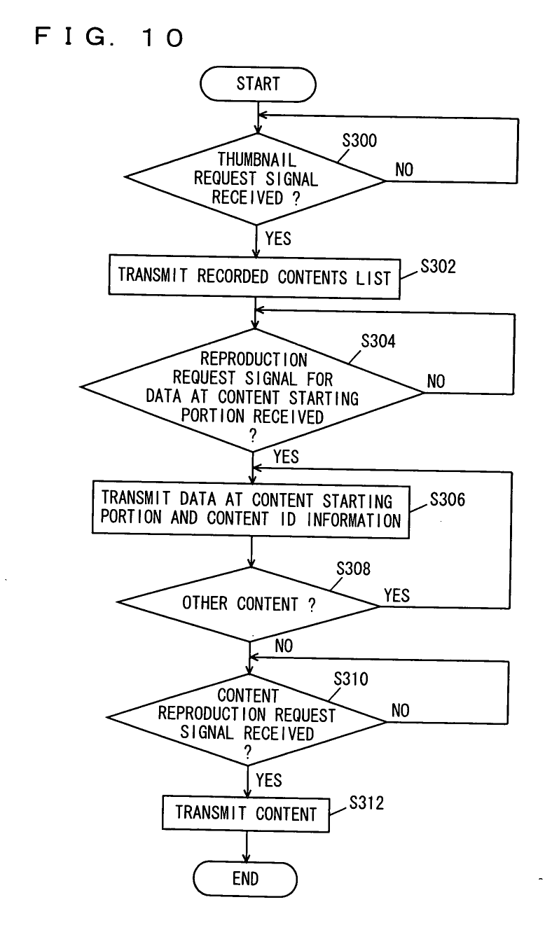

Referring to FIG. 10, the control structure of the program executed by central processing unit 204 of video recording/reproducing device 200 of the video display system in accordance with the present embodiment will be described.

At S300, central processing unit 204 determines whether a thumbnail request signal from video display device 100 has been received or not. If the thumbnail request signal from video display device 100 has been received (YES at S300), the flow proceeds to S302. Otherwise (NO at S300), the flow returns to S300.

At S302, central processing unit 204 transmits a list of contents recorded on disk device 210 to video display device 100. The list of contents is encrypted by encryption unit 206 and thereafter transmitted through transmission/reception unit 208 to video display device 100.

At S304, central processing unit 204 determines whether a reproduction request signal for data at a starting portion of the content has been received from video display device 100 or not. If the reproduction request signal for the data at the starting portion of the content has been received (YES at S304), the flow proceeds to S306. Otherwise (NO at S304), the flow returns to S304.

At S306, central processing unit 204 transmits the data at the starting portion of the content and the content identification information to video display device 100. The data at the starting portion of the content and the content identification information are encrypted by encryption unit 206, and thereafter transmitted through transmission/reception unit 208 to video display device 100. At this time, the data at the starting portion of the content may be transmitted with its size reduced or bit rate lowered.

At S308, central processing unit determines whether there is any other content. When there is any other content (YES at S308), the flow returns to S306. Otherwise (NO at step S308), the flow proceeds to S310. When there are a plurality of contents, a plurality of data at the starting portions of the contents may be transmitted simultaneously. The plurality of data at the starting portions of the contents may be transmitted simultaneously, with their size reduced or bit rate lowered.

At S310, central processing unit 204 determines whether a content reproduction request signal from video display device 100 has been received or not. If the content reproduction request signal from video display device 100 has been received (YES at S310), the flow proceeds to S312. Otherwise (NO at S310), the flow returns to S310.

At S312, central processing unit 204 transmits the content to video display device 100. The content is encrypted by encryption unit 206 and thereafter transmitted through transmission/reception unit 208 to video display device 100.

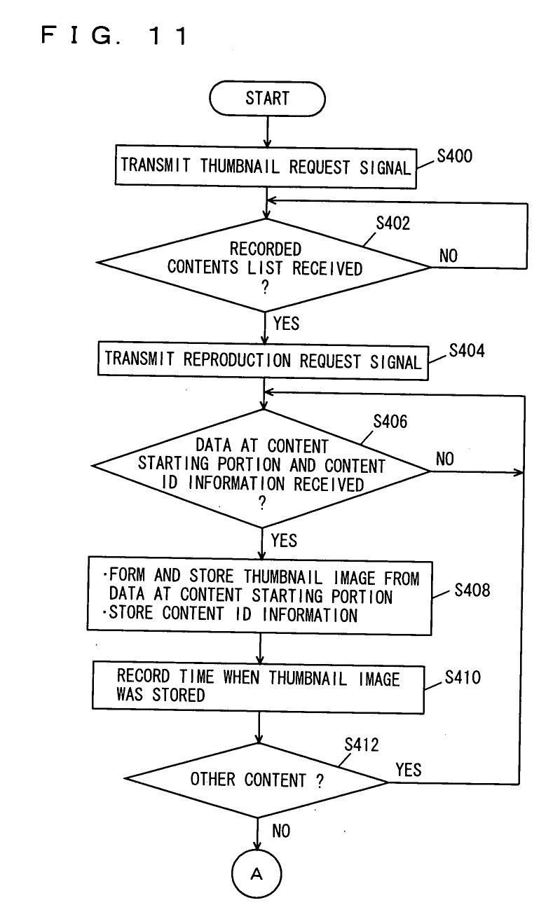

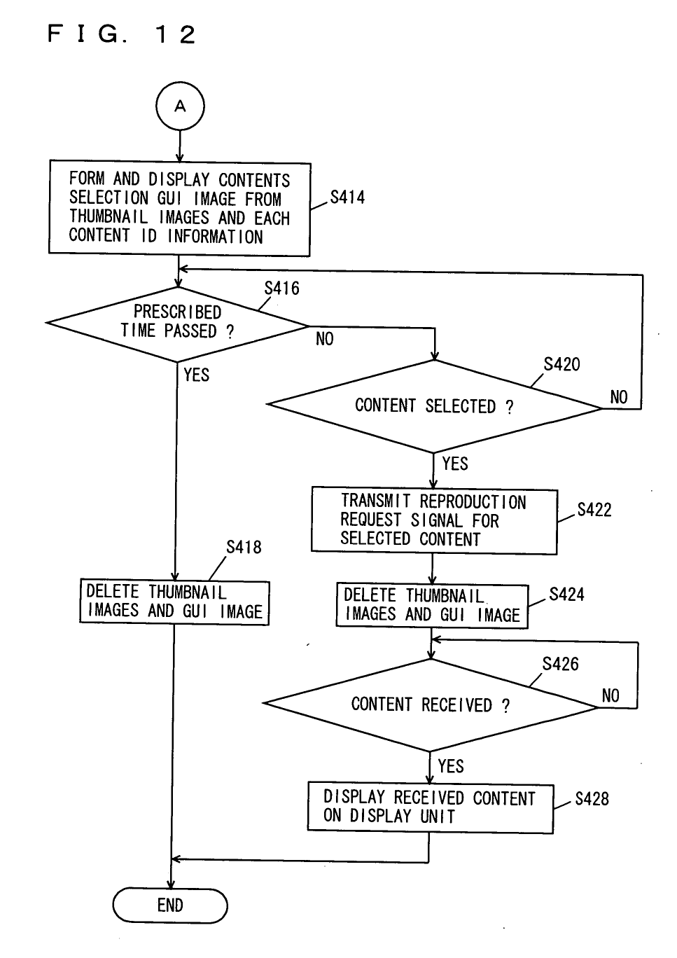

Referring to FIGS. 11 and 12, the control structure of the program executed by central processing unit 102 of video display device 100 in the video display system in accordance with the present embodiment will be described.

At S400, based on a user operation or the like, central processing unit 102 transmits a thumbnail request signal to video recording/reproducing device 200. The thumbnail request signal is transmitted through transmission/reception unit 108 to video recording/reproducing device 200.

At S402, central processing unit 102 determines whether video recording/reproducing device 200 has received a list of recorded contents or not. If the list of recorded contents has been received (YES at S402), the flow proceeds to S404. Otherwise (NO at S402), the flow returns to S402.

At S404, based on the received list, central processing unit 102 transmits the reproduction request signal for the data at the starting portion of a content recorded on disk device 210 of video recording/reproducing device 200, to the video recording/reproducing device.

At S406, central processing unit 102 determines whether the data at the starting portion of the content and the content identification information have been received from video recording/reproducing device 200 or not. When the data at the starting portion of the content and the content identification information have been received (YES at S406), the flow proceeds to S408. Otherwise (NO at S406), the flow returns to S406.

At S408, central processing unit 102 forms a thumbnail image from the data at the starting portion of the content received through transmission/reception unit 108, stores the formed thumbnail, and stores the content identification information. After the data of the starting portion of the content is decrypted, the thumbnail image is formed. The content identification is decrypted at encryption unit 116 and, thereafter, stored in storage unit 10.

At S410, central processing unit 102 records the time point when the thumbnail image was stored. The time point when the thumbnail image was stored is recorded at thumbnail control unit 114.

At S412, central processing unit 102 determines whether there is any other content. If there is any other content (YES at S412), the flow returns to S406. Otherwise (NO at S412), the flow proceeds to S414.

At S414, central processing unit 102 forms a GUI image for contents selection using the thumbnail images stored in thumbnail storage unit 112 and the content identification information stored in storage unit 110, and displays the GUI image on display unit 106 as the contents selection image.

At S416, central processing unit 102 determines whether a prescribed time period has passed from the time point when the thumbnail image was stored. If the prescribed time period has passed from the time point when the thumbnail image was stored (YES at S416), the flow proceeds to S418. Otherwise (NO at S416), the flow proceeds to S420. The prescribed time period may be appropriately determined beforehand by the device or the system. It may be possible to have the prescribed time period changed by the user.

At S418, central processing unit 102 deletes all the thumbnail images that correspond to copy-never contents and the GUI image for contents selection. Deletion of the thumbnail images and the GUI image is done by thumbnail control unit 114.

At S420, central processing unit 102 determines whether a content to be viewed by the user has been selected or not. As shown in FIG. 7, the user selects the content using the contents selection image displayed on display unit 106. The content may be selected by any other method.

When the content is selected (YES at S420), the flow proceeds to S422. Otherwise (NO at S420), the flow proceeds to S416. At S422, central processing unit 102 transmits a reproduction request signal for the selected content to video recording/reproducing device 200. The reproduction request signal for the content is transmitted through transmission/reception unit 108 to video recording/reproducing device 200.

At S424, central processing unit 102 deletes all the thumbnail images corresponding to the copy-never contents among the thumbnail images stored at storage unit 112, and the GUI image for contents selection. Deletion of the thumbnail images and the GUI image is done by thumbnail control unit 114.

At S426, central processing unit 102 determines whether the content has been received from video recording/reproducing device 200. When the content has been received (YES at S426), the flow proceeds to S428. Otherwise (NO at S426), the flow returns to S426.

At S428, central processing unit 102 displays the received content on display unit 106. The content is decrypted at encryption unit 116 and thereafter displayed on display unit 106.

The operation of the video display system in accordance with the present embodiment based on the structure and flowchart as above will be described in the following.

By a user operation or the like, a thumbnail request signal is transmitted from video display device 100 to video recording/reproducing device 200 (S400). When the thumbnail request signal is received on the side of video recording/reproducing device 200 (YES at S300), the list of contents recorded on disk device 210 is transmitted from video recording/reproducing device 200 to video display device 100 (S302).

When the list of recorded contents is received on the side of video display device 100 (YES at S402), a reproduction request signal for the data at the starting portion of the content recorded on disk device 210 of video recording/reproducing device 200 is transmitted from video display device 100 to video recording/reproducing device 200, based on the received list (S404). When the reproduction request signal for the data at the starting portion of the content is received on the side of video recording/reproducing device 200 (YES at S304), the data at the starting portion of the content and the content identification information are transmitted from video recording/reproducing device 200 to video display device 100 (S306).

If there is any other content (YES at S308), transmission of the data at the starting portion of the content and the content identification information (S306) is repeated.

When the data at the starting portion of the content and the content identification information are received on the side of video display device 100 (YES at S406), a thumbnail image is formed from the data at the starting portion of the content, the formed thumbnail image is stored, and the content identification information is stored (S408). Here, the time point when the thumbnail image was stored is recorded in thumbnail control unit 114 (S410).

If there is any other content (YES at S412), the process steps following S406 are repeated. The process steps following S406 are repeated, for example, until all the thumbnail images are formed or until all the thumbnail images that can be displayed on one image plane are formed.

Utilizing the thumbnail images and the pieces of content identification information obtained in this manner, the GUI image for contents selection is formed, and the GUI image is displayed on display unit 106 (S414). In this state, if there is no user operation and the prescribed time period, for example, ten minutes, passes from the time point when the thumbnail image was stored (YES at S416), all the thumbnail images corresponding to the copy-never contents and the GUI image for contents selection are deleted (S418).

When a content is selected through the contents selection image displayed on display unit 106 (YES at S420), a content reproduction request signal is transmitted from video display device 100 to video recording/reproducing device 200 (S422).

At this time, correspondence between the thumbnail image and the original content can be established from the content identification information, and therefore, when the thumbnail image is selected on the contents selection image, a reproduction request signal for the original content is transmitted.

In this state, it follows that the thumbnail images and the GUI image for contents section are no longer necessary. Therefore, among the thumbnail images stored in thumbnail storage unit 112, all the thumbnail images corresponding to the copy-never contents and the GUI image for contents selection are deleted (S424).

When the content reproduction request signal from video display device 100 is received on the side of video recording/reproducing device 200 (YES at S310), the requested content is transmitted to video display device 100 (S312).

When the content is received on the side of video display device 100 (YES at S426), the content is displayed on display unit 106 (S426). Thus, the user views the content. By this arrangement also, effects similar to those of the first embodiment above can be attained.

### Third Embodiment

In the following, a third embodiment of the present invention will be described. The present embodiment differs from the first and second embodiments in that the thumbnail image is deleted when the power of video display device 100 is turned off.

Except for this point, the structure is the same as the first and second embodiments described above. The functions are also the same. Therefore, detailed description thereof will not be repeated here.

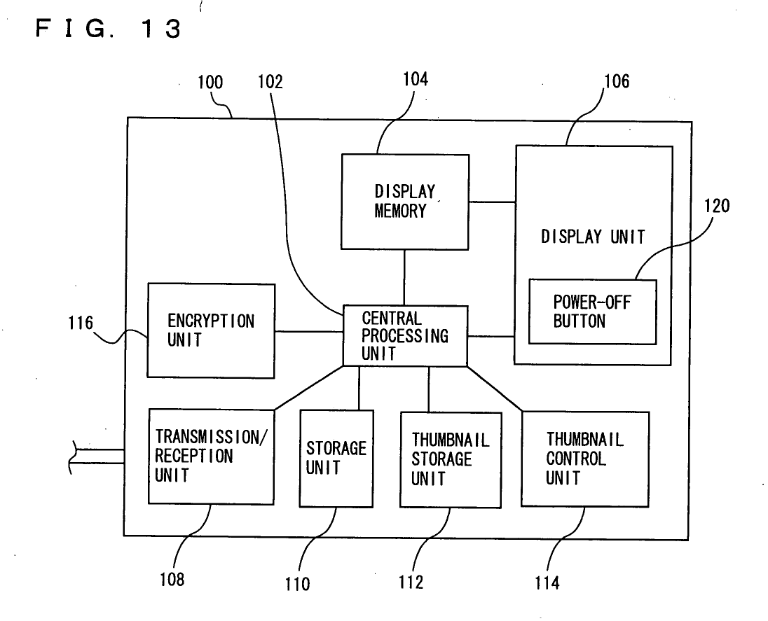

Referring to FIG. 13, video display device 100 of the video display system in accordance with the present embodiment will be described. As shown in FIG. 13, on display unit 106 of video display device 100 in accordance with the present embodiment, a power-off button 120 for instructing power-off is displayed.

The power-off button 120 is similar to one displayed on a image screen of a commonly used personal computer. By clicking the power-off button using a remote controller or a mouse, the user can instruct power-off of video display device 100. The method of turning the power off is not limited to this, and the power-off may be instructed by pressing a keyboard, or by an operation of a mechanical switch.

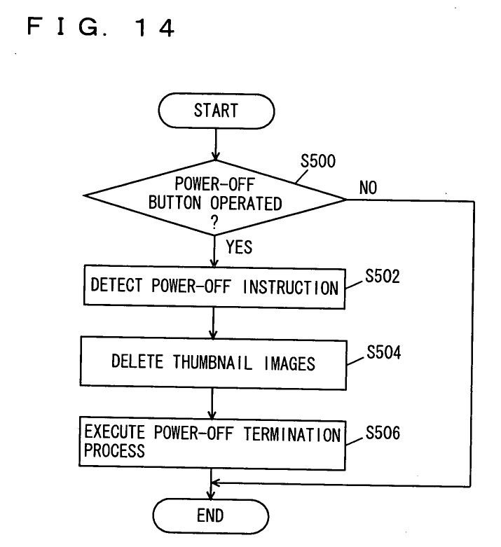

Referring to FIG. 14, the control structure of the program executed by central processing unit 102 of video display device 100 in the video display system in accordance with the present embodiment will be described.

At S500, central processing unit 102 determines whether the power-off button is operated or not. If the power-off button is operated (YES at S500), the flow proceeds to S502. Otherwise (NO at S500), the process ends.

At S502, central processing unit 102 detects an instruction to turn the power off. At S504, central processing unit 102 deletes all the thumbnail images stored in thumbnail storage unit 114. At S506, central processing unit 102 executes a process for terminating the operation of video display device 100.

The operation of video display system in accordance with the present embodiment based on the structure and flowchart above will be described in the following.

When the user operates the power-off button (YES at S500), an instruction to turn the power off is detected (S502), and the thumbnail images stored in thumbnail storage unit 114 are all deleted (S504). Thereafter, a process for terminating the operation of video display device is executed (S506).

Therefore, even when thumbnail storage unit 114 is formed of a non-volatile memory, the thumbnail images can be deleted reliably. Therefore, copying of a content in the form of storing the thumbnail image can be prevented. As a result, even for a copy-never content, a thumbnail image formed based on the content can be displayed, without causing any problem of copy restriction.

### Fourth Embodiment

In the following a fourth embodiment of the present invention will be described. The present embodiment differs from the first embodiment in that a thumbnail image of a content of which number of permitted copies is larger than a number predetermined by the device or system is stored in the storage unit 110 of image display device 100. Except for this point, the structure is the same as the first embodiment described above. The functions are also the same. Therefore, detailed description thereof will not be repeated here.

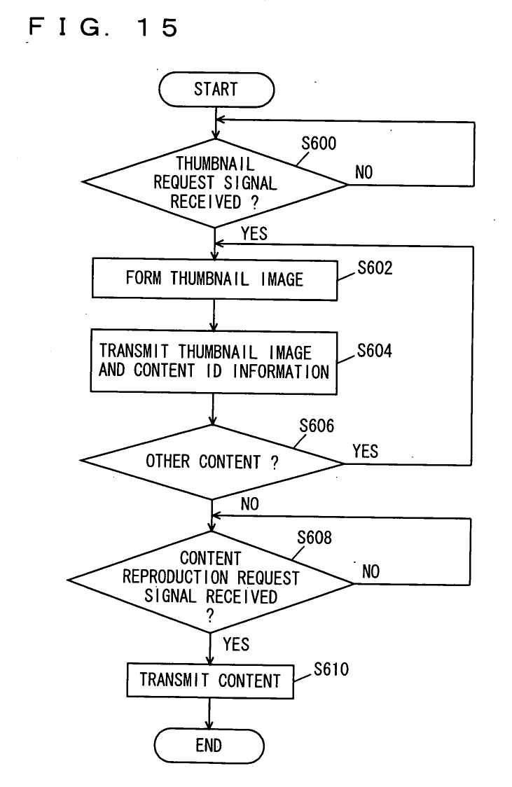

Referring to FIG. 15, the control structure of the program executed by a central processing unit 204 of video recording/reproducing device 200 in the video display system in accordance with the present embodiment will be described.

At S600, central processing unit 204 determines whether a thumbnail request signal from video display device 100 has been received or not. If the thumbnail request signal from video display device 100 has been received (YES at S600), the flow proceeds to S602. Otherwise (NO at S600), the flow returns to S600.

At S602, central processing unit 204 forms a thumbnail image of the content other than the contents corresponding to thumbnail images stored in storage unit 110, among the contents recorded on disk device 210. The thumbnail image is formed at thumbnail forming unit 212.

At S604, central processing unit 204 transmits the thumbnail image thus formed and content identification information, to video display device 100. The thumbnail image and the content identification information are encrypted by encryption unit 206 and transmitted through transmission/reception unit 208 to video display device 100.

At S606, central processing unit 204 determines whether there is any content other than the contents corresponding to the thumbnail images stored in storage unit 110. If there is any other content (YES at S606), the flow returns to S602. Otherwise (NO at S606), the flow proceeds to S608. When there are a plurality of contents, the thumbnail images may be transmitted one by one or transmitted collectively at one time.

At S608, central processing unit 204 determines whether the content reproduction request signal from video display device 100 has been received or not. When the content reproduction request signal from video display device 100 has been received (YES at S608), the flow proceeds to S610. Otherwise (NO at S608), the flow returns to S608.

At S610, central processing unit 204 transmits the content to video display device 100. The content is encrypted at encrypting unit 206, and transmitted through transmission/reception unit 208 to video display device 100.

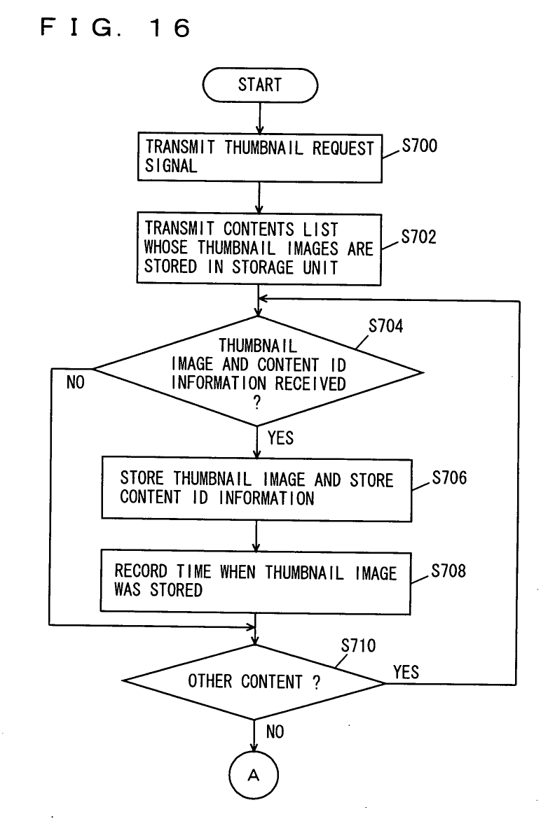

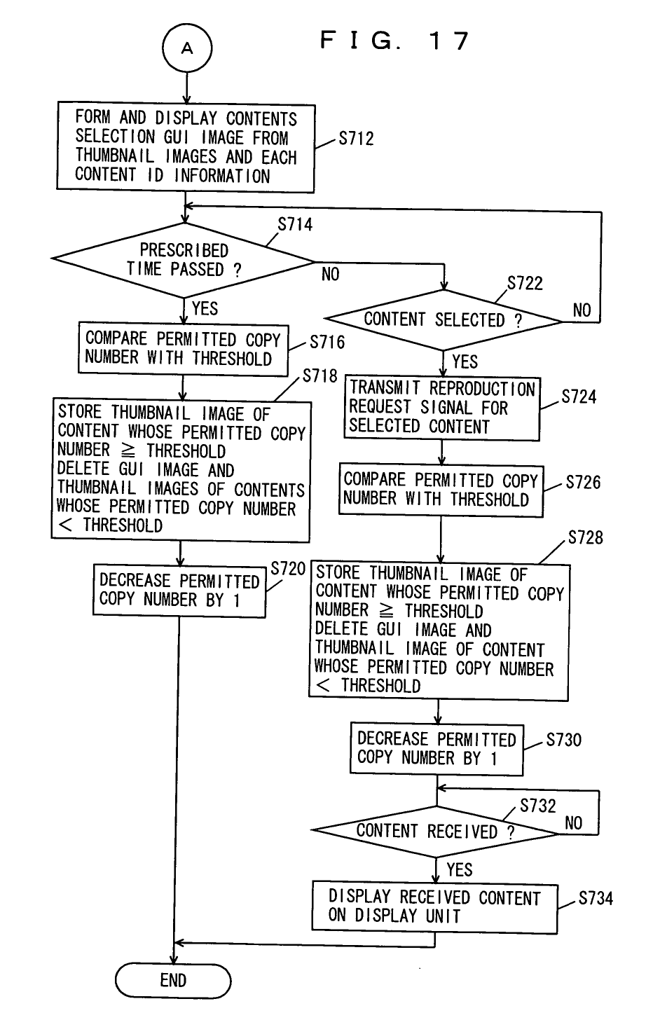

Referring to FIGS. 16 and 17, the control structure of the program executed by central processing unit 102 of video display device 100 in the video display system in accordance with the present embodiment will be described.

At S700, central processing unit 102 transmits a thumbnail request signal to video recording/reproducing device 200 based on, for example, a user operation. The thumbnail request signal is transmitted through transmission/reception unit 108 to video recording/reproducing device 200.

At S702, central processing unit 102 transmits a list of contents of which thumbnail images are stored in storage unit 110, to video recording/reproducing device 200.

At S704, central processing unit 102 determines whether the thumbnail image and the content identification information have been received from video recording/reproducing device 200. If the thumbnail image and the content identification information have been received (YES at S704), the flow proceeds to S706. Otherwise (NO at S704), the flow proceeds to S710.

At S706, central processing unit 102 stores the thumbnail image and stores the content identification information. The thumbnail image is decrypted at encryption unit 116 and thereafter stored in thumbnail storage unit 112. The content identification information is decrypted at encryption unit 116 and thereafter stored in storage unit 110.

At S708, central processing unit 102 records the time point at which the thumbnail image was stored. The time point when the thumbnail image was stored is recorded at thumbnail control unit 114.

At S710, central processing unit 102 determines whether there is any content other than the contents corresponding to the thumbnail images stored in storage unit 110. If there is any other content (YES at S710), the flow proceeds to S702. Otherwise (NO at S710), the flow proceeds to S712.

At S712, central processing unit 102 forms a GUI image for contents selection, utilizing the thumbnail images stored in thumbnail storage unit 112, thumbnail images stored in storage unit 110 and the pieces of content identification information stored in storage unit 110, and displays the GUI image on display unit 106 as a contents selection image.

At S714, central processing unit 102 determines whether a prescribed time period has passed from the time point when the thumbnail image was stored. When the prescribed time period has passed from the time point when the thumbnail image was stored (YES at S714), the flow proceeds to S716. Otherwise (NO at S714), the flow proceeds to S718. The prescribed time may be appropriately determined by the device or the system. It may be possible to have the prescribed time period changed by the user.

At S716, central processing unit 102 compares the number of permitted copies of the content with a threshold value. When there are a plurality of contents, the number of permitted copies of each content is compared with the threshold value. Here, the threshold value is determined beforehand by the device or the system. It may be possible to have the threshold value changed by the user.

At S718, central processing unit 102 stores the thumbnail image corresponding to the content of which number of permitted copies is equal to or larger than the threshold value in storage unit 110, and deletes the GUI image for contents selection and the thumbnail images corresponding to the contents of which number of permitted copies is smaller than the threshold value. Deletion of the GUI image and the thumbnail images is done by thumbnail control unit 114.

At S720, central processing unit 102 decreases by “1” the number of permitted copies of the content corresponding to the thumbnail image stored in storage unit 110.

At S722, central processing unit 102 determines whether a content to be viewed by the user has been selected or not. When the content is selected (YES at S722), the flow proceeds to S724. Otherwise (NO at S722), the flow returns to S714.

At S724, central processing unit 102 transmits a reproduction request signal for the selected content to video recording/reproducing device 200. The reproduction request signal for the content is transmitted through transmission/reception unit 108 to video recording/reproducing device 200.

At S726, central processing unit 102 compares the number of permitted copies of the content with a threshold value. When there are a plurality of contents, the number of permitted copies of each content is compared with the threshold value. Here, the threshold value is determined beforehand by the device or the system. It may be possible to have the threshold value changed by the user.

At S728, central processing unit 102 stores the thumbnail image corresponding to the content of which number of permitted copies is equal to or larger than the threshold value in storage unit 110, and deletes the GUI image for contents selection and the thumbnail images corresponding to the contents of which number of permitted copies is smaller than the threshold value. Deletion of the GUI image and the thumbnail images is done by thumbnail control unit 114.

At S730, central processing unit 102 decreases by ” 1” the number of permitted copies of the content corresponding to the thumbnail image stored in storage unit 110.

At S732, central processing unit 102 determines whether the content has been received from video recording/reproducing device 200. When the content has been received (YES at S724), the flow proceeds to S726. Otherwise (NO at S724), the flow returns to S724.

At S734, central processing unit 102 displays the received content on display unit 106. The content is decrypted at encryption unit 116 and thereafter displayed on display unit 106.

The operation of the video display system in accordance with the present embodiment based on the structure and flowchart as above will be described in the following.

By a user operation or the like, a thumbnail request signal is transmitted from video display device 100 to video recording/reproducing device 200 (S700). As will be described later, the thumbnail image of a content of which number of permitted copies is equal to or larger than the threshold value is stored in storage unit 110, and therefore, a list of contents of which thumbnail images are stored in storage unit 110 is transmitted to video recording/reproducing device 200 (S702).

When the thumbnail request signal is received on the side of video recording/reproducing device 200 (YES at S600), the thumbnail image of the content other than the contents corresponding to the thumbnail images stored in storage unit 110 (S602) is formed. The formed thumbnail image is transmitted, together with the content identification information, to video display device 100 (S604).

If there is any content other than the contents corresponding to the thumbnails stored in storage unit 110 (YES at S606), formation of a thumbnail image (S602) and transmission of the thumbnail image and the content identification information (S604) are repeated.

When the thumbnail image and the content identification information are received on the side of video display device 100 (YES at S704), the thumbnail image is stored in thumbnail storage unit 212 and the content identification information is stored in storage unit 110 (S706). At this time, the time point when the thumbnail image was stored is recorded at thumbnail control unit 114 (S708).

If there is any content other than the contents corresponding to the thumbnail images stored in storage unit 110 (YES at S710), the process steps following S702 are repeated. The process steps following S702 are repeated, for example, until all the thumbnail images are received or until all the thumbnail images that can be displayed on one image plane are received.

Utilizing the thumbnail image received in this manner, the thumbnail images stored in storage unit 110 and the content identification information, the GUI image for contents selection is formed, and the GUI image is displayed on display unit 106 (S712).

In this state, if there is no user operation and the prescribed time period, for example, ten minutes passes from the time point when the thumbnail image was stored (YES at S714), the number of permitted copies of the content is compared with the threshold value (S716).

The thumbnail image corresponding to the content of which number of permitted copies is equal to or larger than the threshold value is stored in storage unit 110 (S718). The GUI image for contents selection and the thumbnail image corresponding to the content of which number of permitted copies is smaller than the threshold value are deleted (S718). The number of permitted copies of the content corresponding to the thumbnail image stored in storage unit 110 is decreased by “1” (S720).

When a content is selected through the contents selection image displayed on display unit 106 (YES at S722), a content reproduction request signal is transmitted from video display device 100 to video recording/reproducing device 200 (S724).

At this time, correspondence between the thumbnail image and the original content can be established from the content identification information, and therefore, when the thumbnail image is selected on the contents selection image, a reproduction request signal for the original content is transmitted.

Here again, the number of permitted copies of the content is compared with the threshold value (S726). The thumbnail image corresponding to the content of which number of permitted copies is equal to or larger than the threshold value is stored in storage unit 110 (S728). The GUI image and the thumbnail image corresponding to the content of which number of permitted copies is smaller than the threshold value are deleted (S728). The number of permitted copies of the content corresponding to the thumbnail image stored in storage unit 110 is decreased by “1” (S730).

When the content reproduction request signal from video display device 100 is received on the side of video recording/reproducing device 200 (YES at S608), the requested content is transmitted to video display device 100 (S610).

When the content is received on the side of video display device 100 (YES at S724), the content is displayed on display unit 106 (S726). Thus, the user views the content. By this arrangement also, effects similar to those of the first embodiment above can be attained.

### Fifth Embodiment

In the following a fifth embodiment of the present invention will be described. The present embodiment differs from the second embodiment in that a thumbnail image of a content of which number of permitted copies is larger than a number predetermine by the device or system is stored in the storage unit 110 of image display device 100. Except for this point, the structure is the same as the second embodiment described above. The functions are also the same. Therefore, detailed description thereof will not be repeated here.

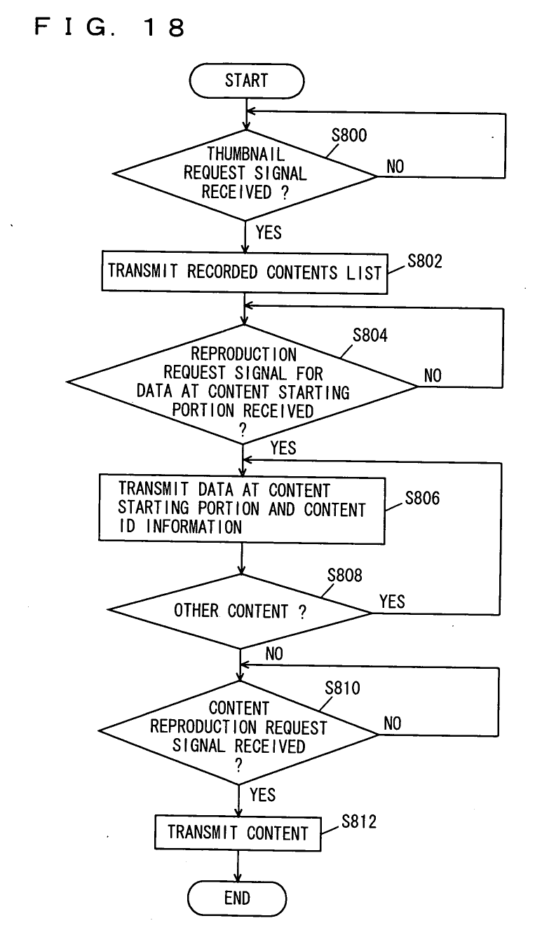

Referring to FIG. 18, the control structure of the program executed by a central processing unit 204 of video recording/reproducing device 200 in the video display system in accordance with the present embodiment will be described.

At S800, central processing unit 204 determines whether a thumbnail request signal from video display device 100 has been received or not. If the thumbnail request signal from video display device 100 has been received (YES at S800), the flow proceeds to S802. Otherwise (NO at S800), the flow returns to S800.

At S802, central processing unit 204 transmits a list of contents recorded on disk device 210 to video display device 100. The list of contents is encrypted by encryption unit 206 and thereafter transmitted through transmission/reception unit 208 to video display device 100.

At S804, central processing unit 204 determines whether a reproduction request signal for data at a starting portion of the content has been received from video display device 100 or not. If the reproduction request signal for the data at the starting portion of the content has been received (YES at S804), the flow proceeds to S806. Otherwise (NO at S804), the flow proceeds to S804.

At S806, central processing unit 204 transmits the data at the starting portion of the content and the content identification information to video display device 100. The data at the starting portion of the content and the content identification information are encrypted by encryption unit 206, and thereafter transmitted through transmission/reception unit 208 to video display device 100. At this time, the data at the starting portion of the content may be transmitted with its size reduced or bit rate lowered.

At S808, central processing unit determines whether there is any other content. When there is any other content (YES at S808), the flow returns to S806. Otherwise (NO at step S808), the flow proceeds to S810. When there are a plurality of contents, a plurality of data at the starting portions of the contents may be transmitted simultaneously. The plurality of data at the starting portions of the contents may be transmitted simultaneously, with their size reduced or bit rate lowered.

At S810, central processing unit 204 determines whether a content reproduction request signal from video display device 100 has been received or not. If the content reproduction request signal from video display device 100 has been received (YES at S810), the flow proceeds to S812. Otherwise NO at S810), the flow returns to S810.

At S812, central processing unit 204 transmits the content to video display device 100. The content is encrypted by encryption unit 206 and thereafter transmitted through transmission/reception unit 208 to video display device 100.

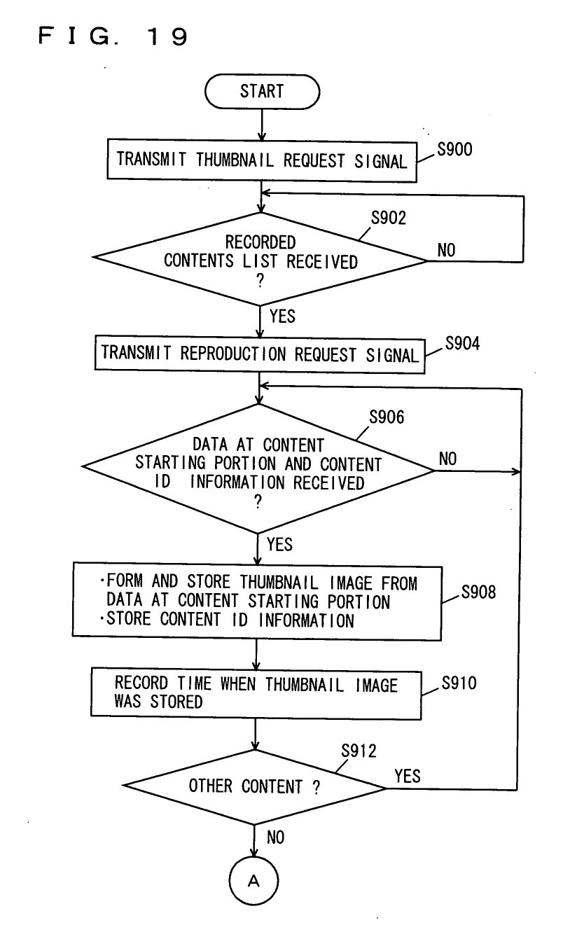

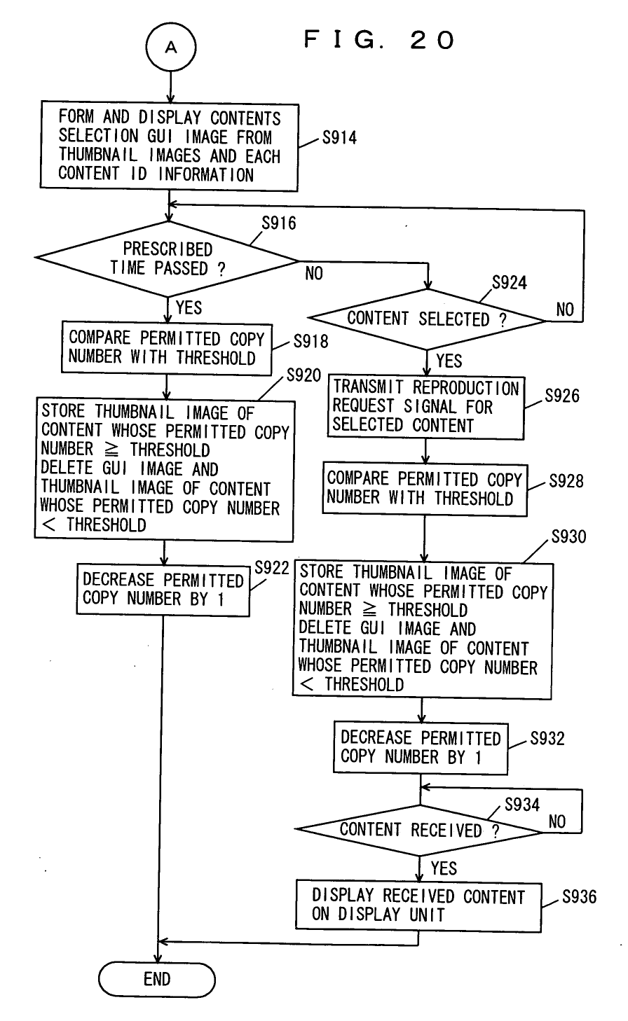

Referring to FIGS. 19 and 20, the control structure of the program executed by central processing unit 102 of video display device 100 in the video display system in accordance with the present embodiment will be described.

At S900, based on a user operation or the like, central processing unit 102 transmits a thumbnail request signal to video recording/reproducing device 200. The thumbnail request signal is transmitted through transmission/reception unit 108 to video recording/reproducing device 200.

At S902, central processing unit 102 determines whether video recording/reproducing device 200 has received a list of recorded contents or not. If the list of recorded contents has been received (YES at S902), the flow proceeds to S904. Otherwise (NO at S902), the flow returns to S902.

At S904, based on the received list, central processing unit 102 transmits the reproduction request signal of the data at the starting portion of a content other than the contents corresponding to the thumbnail images stored in storage unit 110, among the contents recorded on disk device 210 of video recording/reproducing device 200, to the video recording/reproducing device.

At S906, central processing unit 102 determines whether the data at the starting portion of the content other than the contents corresponding to the thumbnail images stored in storage unit 110 and the content identification information have been received from video recording/reproducing device 200 or not. When the data at the starting portion of the content and the content identification information have been received (YES at S906), the flow proceeds to S908. Otherwise (NO at S906), the flow returns to S906.

At S908, central processing unit 102 forms a thumbnail image from the data at the starting portion of the content received through transmission/reception unit 108, stores the formed thumbnail, and stores the content identification information. After the data of the starting portion of the content is decrypted, the thumbnail image is formed. The content identification is decrypted at encryption unit 116 and, thereafter, stored in storage unit 110.

At S910, central processing unit 102 records the time point when the thumbnail image was stored. The time point when the thumbnail image was stored is recorded at thumbnail control unit 114.

At S912, central processing unit determines whether there is any content other than the contents corresponding to the thumbnail images stored in storage unit 110. If there is any other content (YES at S912), the flow returns to S906. Otherwise (NO at S912), the flow proceeds to S914.

At S914, central processing unit 102 forms a GUI image for contents selection using the thumbnail image stored in thumbnail storage unit 112, thumbnail images stored in storage unit 110 and the content identification information stored in storage unit 110, and displays the GUI image on display unit 106 as the contents selection image.

At S916, central processing unit 102 determines whether a prescribed time period has passed from the time point when the thumbnail image was stored in thumbnail storage unit 112. If the prescribed time period has passed from the time point when the thumbnail image was stored (YES at S916), the flow proceeds to S918. Otherwise (NO at S916), the flow proceeds to S920. The prescribed time period may be appropriately determined beforehand by the device or the system. It may be possible to have the prescribed time period changed by the user.

At S918, central processing unit 102 compares the number of permitted copies of the content with a threshold value. When there are a plurality of contents, the number of permitted copies of each content is compared with the threshold value. Here, the threshold value is determined beforehand by the device or the system. It may be possible to have the threshold value changed by the user.

At S920, central processing unit 102 stores the thumbnail image corresponding to the content of which number of permitted copies is equal to or larger than the threshold value in storage unit 110, and deletes the GUI image for contents selection and the thumbnail images corresponding to the content of which number of permitted copies is smaller than the threshold value. Deletion of the GUI image and the thumbnail images is done by thumbnail control unit 114.

At S922, central processing unit 102 decreases by “1” the number of permitted copies of the content corresponding to the thumbnail image stored in storage unit 110.

At S922, central processing unit 102 determines whether a content to be viewed by the user has been selected or not. The user selects a content using the contents selection image displayed on display unit 106, as shown in FIG. 7 described above. The content may be selected by any other method.

When the content is selected (YES at S924), the flow proceeds to S926. Otherwise (NO at S924), the flow returns to S916. At S926, central processing unit 102 transmits a reproduction request signal for the selected content to video recording/reproducing device 200. The reproduction request signal for the content is transmitted through transmission/reception unit 108 to video recording/reproducing device 200.

At S928, central processing unit 102 compares the number of permitted copies of the content with a threshold value. When there are a plurality of contents, the number of permitted copies of each content is compared with the threshold value. Here, the threshold value is determined beforehand by the device or the system. It may be possible to have the threshold value changed by the user.

At S930, central processing unit 102 stores the thumbnail image corresponding to the content of which number of permitted copies is equal to or larger than the threshold value in storage unit 110, and deletes the GUI image for contents selection and the thumbnail images corresponding to the contents of which number of permitted copies is smaller than the threshold value. Deletion of the GUI image and the thumbnail images is done by thumbnail control unit 114.

At S932, central processing unit 102 decreases by ” 1I” the number of permitted copies of the content corresponding to the thumbnail image stored in storage unit 110.

At S934, central processing unit 102 determines whether the content has been received from video recording/reproducing device 200. When the content has been received (YES at S934), the flow proceeds to S936. Otherwise (NO at S934), the flow returns to S934.

At S936, central processing unit 102 displays the received content on display unit 106. The content is decrypted at encryption unit 116 and thereafter displayed on display unit 106.

The operation of the video display system in accordance with the present embodiment based on the structure and flowchart as above will be described in the following.

By a user operation or the like, a thumbnail request signal is transmitted from video display device 100 to video recording/reproducing device 200 (S900). When the thumbnail request signal is received on the side of video recording/reproducing device 200 (YES at S800), the list of contents recorded on disk device 210 is transmitted from video recording/reproducing device 200 to video display device 100 (S802).

When the list of recorded contents is received on the side of video display device 100 (YES at S902), a reproduction request signal for the data at the starting portion of the content, other than the contents corresponding to the thumbnail images stored in storage unit 110, among the contents recorded on disk device 210 of video recording/reproducing device 200 is transmitted from video display device 100 to video recording/reproducing device 200, based on the received list (S904). When the reproduction request signal for the data at the starting portion of the content is received on the side of video recording/reproducing device 200 (YES at S804), the data at the starting portion of the content and the content identification information are transmitted from video recording/reproducing device 200 to video display device 100 (S806).

If there is any content other than the contents corresponding to the thumbnail images stored in storage unit 110 (YES at S808), transmission of the data at the starting portion of the content and the content identification information (S806) is repeated.

When the data at the starting portion of the content and the content identification information are received on the side of video display device 100 (YES at S906), a thumbnail image is formed from the data at the starting portion of the content, the formed thumbnail image is stored, and the content identification information is stored (S908). Here, the time point when the thumbnail image was stored is recorded in thumbnail control unit 114 (S910).

If there is any content other than the contents corresponding to the thumbnail images stored in storage unit 110 (YES at S912), the process steps following S906 are repeated. The process steps following S906 are repeated, for example, until all the thumbnail images are formed or until all the thumbnail images that can be displayed on one image plane are formed.

Utilizing the thumbnail image, the thumbnail images stored in storage unit 110 and the content identification information obtained in this manner, the GUI image for contents selection is formed, and the GUI image is displayed on display unit 106 (S914). In this state, if there is no user operation and the prescribed time period, for example, ten minutes passes from the time point when the thumbnail image was stored (YES at S916), the number of permitted copies of the content is compared with the threshold value (S918).

The thumbnail image corresponding to the content of which number of permitted copies is equal to or larger than the threshold value is stored in storage unit 110 (S920). The GUI image for contents selection and the thumbnail image corresponding to the content of which number of permitted copies is smaller than the threshold value are deleted (S920). The number of permitted copies of the content corresponding to the thumbnail image stored in storage unit 110 is decreased by “1” (S922).

When a content is selected through the contents selection image displayed on display unit 106 (YES at S924), a content reproduction request signal is transmitted from video display device 100 to video recording/reproducing device 200 (S926).

At this time, correspondence between the thumbnail image and the original content can be established from the content identification information, and therefore, when the thumbnail image is selected on the contents selection image, a reproduction request signal for the original content is transmitted.

Here again, the number of permitted copies of the content is compared with the threshold value (S928). The thumbnail image corresponding to the content of which number of permitted copies is equal to or larger than the threshold value is stored in storage unit 110 (S930). The GUI image and the thumbnail image corresponding to the content of which number of permitted copies is smaller than the threshold value are deleted (S930). The number of permitted copies of the content corresponding to the thumbnail image stored in storage unit 110 is decreased by “1” (S932).

When the content reproduction request signal from video display device 100 is received on the side of video recording/reproducing device 200 (YES at S810), the requested content is transmitted to video display device 100 (S812).

When the content is received on the side of video display device 100 (YES at S934), the content is displayed on display unit 106 (S936). Thus, the user views the content. By this arrangement also, effects similar to those of the second embodiment above can be attained.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A video display device displaying an image formed based on a content, comprising:
a forming unit forming said image based on said content;
a storage unit storing said image;
a display unit on which the stored image is displayed; and
a deleting unit deleting the image stored in said storage unit based on information defining condition of use of said content.

2. The video display device according to claim 1, wherein
said information defining the condition of use of said content is number of permitted copies of said content.

3. The video display device according to claim 2, wherein
said deleting unit deletes, when a predetermined condition is satisfied, an image formed based on a content of which number of permitted copies is smaller than a prescribed number.

4. The video display device according to claim 3, wherein
said predetermined condition is that a predetermined time has passed from when said image was stored.

5. The video display device according to claim 3, wherein
said predetermined condition is that said image is selected for viewing said content.

6. The video display device according to claim 3, wherein
said predetermined condition is that power of said video display device is turned off.

7. The video display device according to claim 2, further comprising
a processing unit performing a process not to delete an image formed based on a content of which number of permitted copies is larger than a predetermined number.

8. The video display device according to claim 1, wherein
said storage unit is formed of a volatile memory.

9. The video display device according to claim 1, further comprising
a volatile display memory storing data to be transmitted to said display unit; wherein
said storage unit is formed by said display memory.

10. The video display device according to claim 1, further comprising
an obtaining unit obtaining the content and the information defining the condition of use of said content from a device different from said video display device.

11. A video display system comprising:
the video display device according to claim 10; and
a providing device connected through a network to said video display device, and providing said content and said information defining the condition of use of said content to said video display device.

12. A video display device displaying an image formed based on a content, comprising:
forming means for forming said image based on said content;
storage means for storing said image;
a display unit on which the stored image is displayed; and
deleting means for deleting the image stored in said storage means based on information defining condition of use of said content.

13. The video display device according to claim 12, wherein
said information defining the condition of use of said content is number of permitted copies of said content.

14. The video display device according to claim 13, wherein
said deleting means includes means for deleting, when a predetermined condition is satisfied, an image formed based on a content of which number of permitted copies is smaller than a prescribed number.

15. The video display device according to claim 14, wherein
said predetermined condition is that a predetermined time has passed from when said image was stored.

16. The video display device according to claim 14, wherein
said predetermined condition is that said image is selected for viewing said content.

17. The video display device according to claim 14, wherein
said predetermined condition is that power of said video display device is turned off.

18. The video display device according to claim 13, further comprising
processing means for performing a process not to delete an image formed based on a content of which number of permitted copies is larger than a predetermined number.

19. The video display device according to claim 12, wherein
said storage means is formed of a volatile memory.

20. The video display device according to claim 12, further comprising
a volatile display memory storing data to be transmitted to said display unit; wherein
said storage means is formed by said display memory.

21. The video display device according to claim 12, further comprising
obtaining means for obtaining the content and the information defining the condition of use of said content from a device different from said video display device.

22. A video display system comprising:
the video display device according to claim 21; and
a providing device connected through a network to said video display device, and providing said content and said information defining the condition of use of said content to said video display device.
